(19) United States
(12) Patent Application Publication
(10) Pub. No.: US 2016/0180871 A1
(43) Pub. Date: Jun. 23, 2016

(54) COATING MAGNETIC TAPE HEADS

(71) Applicant: HEWLETT-PACKARD DEVELOPMENT COMPANY, L.P., Houston, TX (US)

(72) Inventors: Brian Brong, Boise, ID (US); Mike Alan Holmberg, Boise, ID (US); Charles Calvin Brooks Partee, Boulder, CO (US); Paul W Poorman, Boise, ID (US); Mike Sharrock, Boise, ID (US); Geoff Spratt, Boise, ID (US); Scott Swanbeck, Boise, ID (US)

(21) Appl. No.: 14/908,772

(22) PCT Filed: Jul. 31, 2013
(86) PCT No.: PCT/US2013/052891

§ 371 Date: Jan. 29, 2016

(51) Int. Cl. G11B 5/40; G11B 5/008

(52) U.S. Cl. CPC G11B 5/40; G11B 5/00813

(57) ABSTRACT

Techniques for protecting tape heads from wear are provided. In an example, a method includes forming a coating over elements on the magnetic tape head, wherein the elements can comprise read elements, write elements, or both and wherein the coating does not extend over adjacent tape bearing surfaces.

### BACKGROUND

Magnetic tape drives provide a tool for storing large amounts of data, for example, for performing backups. However, the motion of the magnetic tape across the tape bearing surfaces of the magnetic recording head can cause wear for various reasons. For example, frictional erosion can wear away the material of the head's active elements. Further, the friction of the tape across the head can lead to tribocharging, which can cause electrochemical wear of the tape head. The removal of material from the read/write elements and the surrounding dielectric can be referred to as pole tip recession (PTR). PTR can increase the spacing between the active elements and the magnetic tape, leading to reduced performance and head failure.

### BRIEF DESCRIPTION OF THE DRAWINGS

Certain exemplary embodiments are described in the following detailed description and in reference to the drawings, in which:

FIG. 1 is a drawing of a tape drive mechanism with a tape cartridge inserted;

FIG. 2 is a schematic view of a tape drive system;

FIG. 3 is a drawing of a tape surface, illustrating the saved bits;

FIG. 4 is a drawing of a current read/write head;

FIG. 5 is a drawing of a current coated read/write head;

FIGS. 6A and 6B are cross sectional views of a current coated read/write head;

FIG. 7 is a drawing of a read/write head that has a coating that is only formed over the insulating layer holding the read/write elements;

FIGS. 8A and 8B are cross sectional views of a read/write head that has the coating formed only over the insulating region; and

FIG. 9 is a method for forming a coating on a magnetic tape head over the read elements, the write elements, or both.

### DETAILED DESCRIPTION OF SPECIFIC EMBODIMENTS

Dimensions in recording systems have continuously been decreasing in order to increase the amount of data that can be stored. Included in this trend is the magnetic spacing between the magnetic transducer that reads and writes data, such as a read/write head, and the magnetic layer that records the data. Magnetic spacing is an important parameter because the amplitude of a playback signal decreases exponentially with increasing magnetic spacing. Increased magnetic spacing increases the width of the read back pulse which leads to reduced data densities that can be recorded. The quality of the write operation also varies with spacing and decreased magnetic spacing tends to improve the quality of the write operation.

A coating may often be used over a tape head to protect it from wear and erosion from interaction between the tape head and the magnetic tape, which can lead to pole-tip recession, However, this coating increases magnetic spacing, which is an undesired effect. Currently, the coating is applied over the tape head, including all tape bearing surfaces. As described in examples herein, the coating can be localized to only the area that is needed to improve wear performance. In many examples, removing the coating from areas where it is not needed reduces the magnetic spacing and concomitantly improves the performance of the system. In other circumstances, by removing the coating where it is not needed, process defects that can be associated with the coating, such as electrical shorting, can be mitigated.

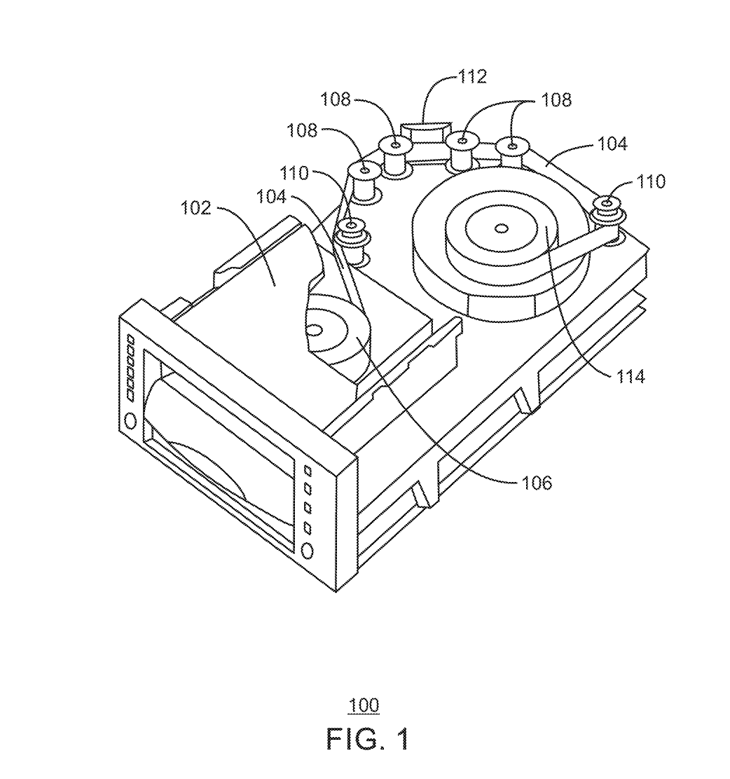

FIG. 1 is a drawing of a tape drive mechanism 100 with a tape cartridge 102 inserted. The tape cartridge 102 supplies the magnetic tape 104, which is stored on a supply reel 106. Upon insertion into the tape drive mechanism 100, the magnetic tape 104 is automatically threaded around a number of tape guides 108 and drive rollers 110, and across a read/write head 112, to be collected on a take-up reel 114.

As the magnetic tape 104 is pulled across the read/write head 112, it may cause wear on softer surfaces. For example, an insulating layer that holds the read/write elements may be eroded, while the harder tape bearing surfaces adjacent to the insulating layer remain unchanged. As a result, the separation between the tape and the read/write elements may increase. To mitigate this, in an example described herein, the read/write elements of the read/write head 112 have a protective coating applied to protect them from damage.

The tape drive mechanism 100 does not have to have the configuration shown in FIG. 1. In some examples, the tape drive mechanism 100 may have a tape cartridge 102 that includes both the supply reel 102 and take-up reel 114. In other embodiments, the magnetic tape 104 may be supplied from an open supply reel 102 to an open take-up reel 114, without an enclosing cartridge. In all of these examples, the protective coating may be useful for reducing wear.

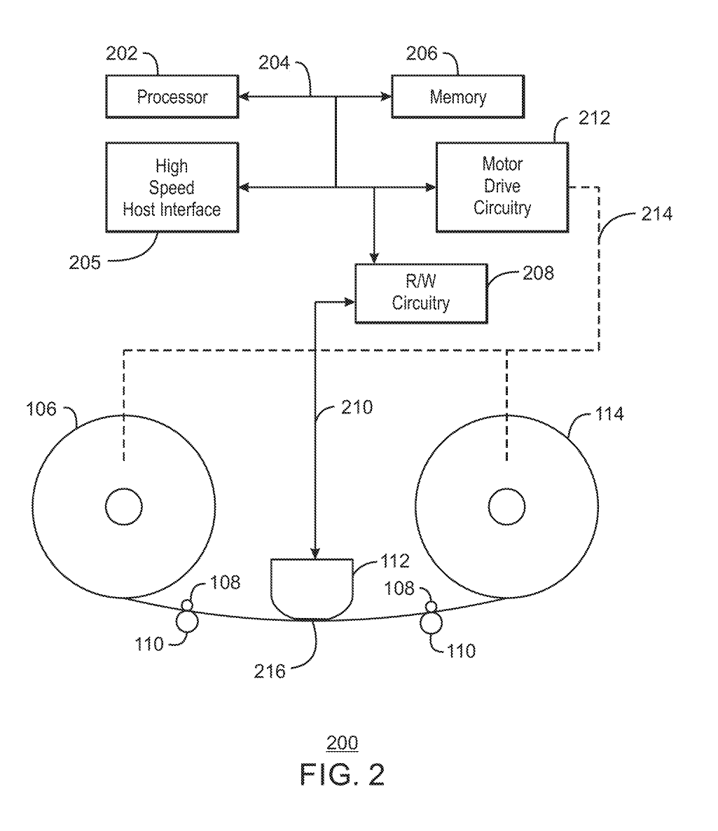

FIG. 2 is a schematic view of a tape drive system 200. Like numbered items are as discussed with respect to FIG. 1. The schematic view illustrates circuit and software blocks that can be used to read data from a magnetic tape 104. The tape drive system 200 may have a processor 202 that is coupled to a number of other units over a bus 204. The processor 202 may be a microprocessor, a multicore processor, custom ASIC or any number of other units. The bus 204 can be a typical processor bus, such as an ISA bus, an EISA bus, a PCI bus, a PCIe bus, a proprietary bus, or any number of other types of buses. If the tape drive system 200 is part of a network backup system in a larger implementation, multiple tape drives may be controlled through a high speed host interface 205 such as, but not limited to, SATA, SAS, or Fibre Channel, among others.

A memory 206 may be coupled to the bus 204 to hold instructions for the processor 202. In an example, the memory 206 holds instructions that direct the processor 202 to access a read/write circuit 208, which is coupled to read/write elements in the read/write head 112 through R/N Lines 210. The instructions can also direct the processor 202 to access a motor drive 214 over the bus 204. The motor drive 216 is coupled through motor power lines 218 to motors that move the magnetic tape 104 between the reels 106 and 114, sliding the tape across the read/write head 112.

The read/write head 112 can have a protective coating 216 that protects the read/write elements from wear. In an example, the protective coating 216 is formed over just the read/write elements in the read/write head 112, and the other tape bearing surfaces are left uncovered. This will reduce wear on the read/write elements while allowing closer magnetic spacing between the tape and the read/write elements.

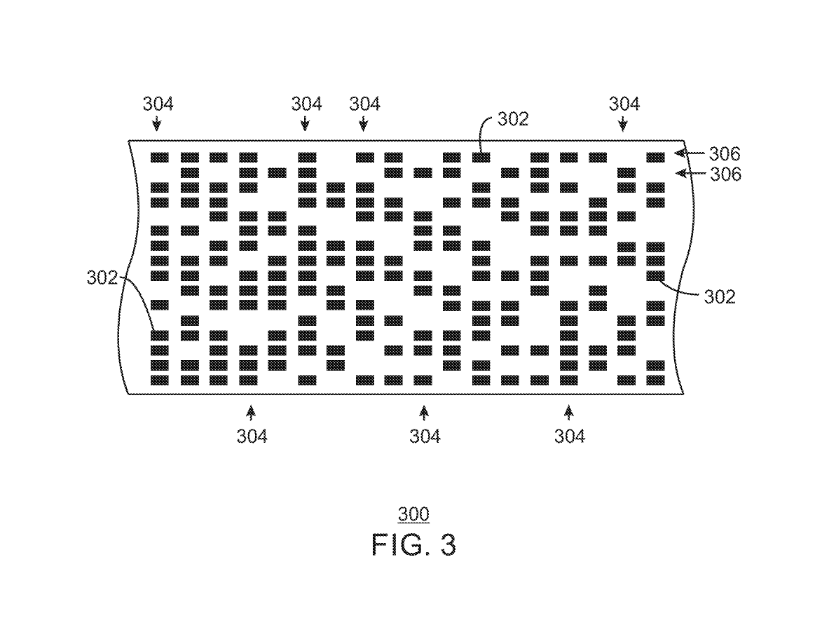

FIG. 3 is a drawing of a tape surface 300, illustrating the saved bits 302. In the example shown, the tape surface stores 16 bits at each data column 304, with each bit corresponding to a read/write element in a read/write head. To simplify the drawing only examples of the bits and rows are labeled. In some examples, 32 read/write elements, or more, can be used to provide even more bits per row. The resulting small size of a read/write element may make these vulnerable to damage. Further, while one or more bits may be used as parity bits 306, even a small amount of intermittent failures to correctly read or write a bit may compromise the system. As greater damage accrues, for example, due to wear of a tape head, the system may become progressively unreliable, for example, decreasing the amount of data that can be stored on a tape. Although coatings can protect a tape head from wear, they may also increase the magnetic separation between the read/write elements and the tape, which may also decrease the reliability.

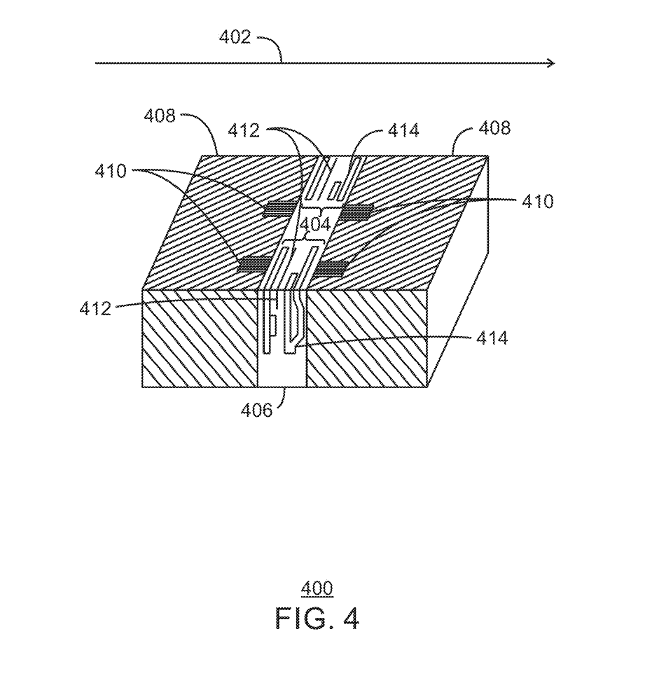

FIG. 4 is a drawing of an example of a current read/write head 400. Two sets of read/write elements 404 are illustrated. The read/write elements 404 are embedded in an insulating region 406, for example, formed from alumina (Al₂O₃). On either side of the insulating region 406 are other tape bearing surfaces (TBS) 408. The TBS 408 are hard surfaces that facilitate the smooth motion of the tape across the read/write elements 404 and act as reference planes. It should be understood that many different head architectures are possible, as is known to those skilled in the art. For example, the read and write elements can be formed on the same substrate but be located a distance apart, such as several microns, with an insulating layer between them. In another example, the read and write elements can be formed on different substrates and be glued together. In another example, the read and write elements can be in separate heads entirely.

In an example, the TBS 408 are made from an alumina-titanium carbide composite (Al₂O₃—TiC) called AlTiC. Generally, thin film magnetic heads are fabricated by building the devices on a ceramic substrate commonly referred to as a “wafer.” The base layer of the wafer may be the AlTiC. AlTiC is generally electrically conductive and typically includes approximately 30-35% by weight TiC, 24-28 wt. % Ti, 6-7 wt % C, with the remainder Al2O₃. The read/write elements are deposited in an Al₂O₃ layer, termed the insulating region 406, herein, on top of the AlTiC wafer. Another layer of AlTiC is then glued over the insulating layer 406, using, for example, an epoxy. Fiducial marks 410 that are formed in, or on, the AlTiC layer or in, or on, the layers that form the read/write elements. The fiducial marks 410 can be used to facilitate alignment of the two TBS 408 layers during assembly. The multi-layer construct is then sliced along the read/write elements 404 to form the read/write heads. In some examples, additional layers are deposited over the AlTiC wafers to form the structures shown.

As the tape head wears, the insulating region 406 holding the read/write elements 404 may experience wear at a higher rate than the AlTiC of the TBS 408. This can cause the read/write elements to retract below the surface of the surrounding TBS 408, leading to increased magnetic separation and less reliability during reading and writing. The different elements of the read/write head 400 may differ in sensitivity to wear. For example, the read elements 412 may be more sensitive to wear than the write elements 414. Further, the read elements 412 and write elements 414 do not have to be integrated into a single Al2O₃ structure, but may be formed in separate structures and joined together.

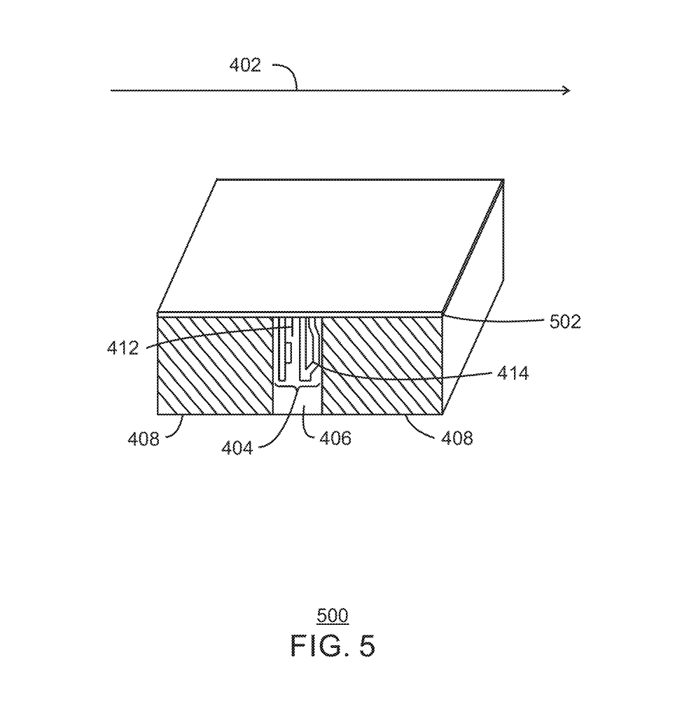

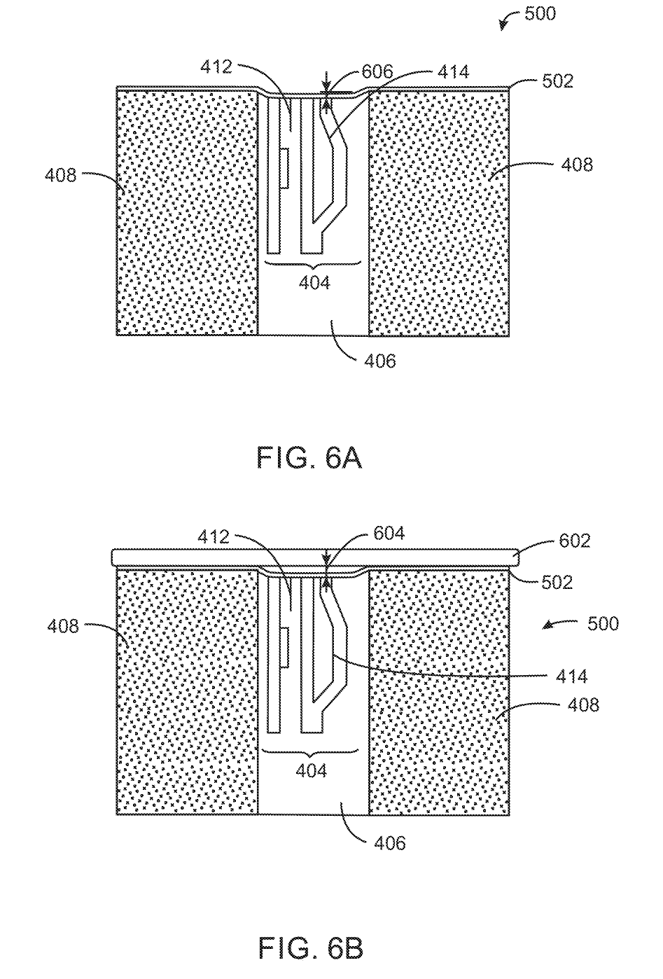

FIG. 5 is a drawing of a current coated read/write head 500. Like numbered items are as discussed with respect to FIG. 4. To protect the read/write elements 404 from wear, a coating 502 can be applied over the entire surface of the read/write head 500. The coating 502 is discussed further in the cross-sectional view shown in FIGS. 6A and 6B.

FIGS. 6A and 6B are cross sectional views of a current coated read/write head 500. Like numbered items are as discussed with respect to FIGS. 4 and 5. In some examples, the coating 502 is a bi-layer structure that includes a lower layer that is an electrical insulator, for example, silicon nitride (SiN), and an upper layer of a wear resistant material, such as Ti/TiO₂. In some examples, the coating 502 may be a multi-layer laminate, for example, SiN/Ti/SiN/Ti. It can be noted that this is not a composite, as the TiO₂ is formed coincidently to the deposition of titanium. In some cases, the insulation layer and the wear resistant layer can each be several nm thick, such as 6 nm thick each. In other examples, the coating 502 can be a single layer structure that is insulating and wear resistant. In current applications, the coating 502 is applied by sputter deposition over the entire read/write head 500, including the TBS 408 and the read/write elements 404. The coating 502 protects the read elements 412 and write elements 414 from wear, substantially improving the reliability of the tape head 500.

However, the coating 502 increases the magnetic spacing, indicated in FIG. 6B by an arrow 604, between the magnetic tape 602 and the read/write elements 404. The magnetic spacing 604 is increased by the thickness of the coating layer, e.g., by about 12 nm for the example mentioned above, neglecting any effects from variation in pole tip recession. Pole tip recession, indicated by an arrow 606 in FIG. 6A, is the variation in depth between the insulating layer 406 and the adjacent TBS 408 and is often around 10 nm in depth.

The increase in magnetic spacing degrades the readback SNR. In some examples, it can degrade the readback SNR by several dB. Since the nominal magnetic spacing for current high density recording units may be roughly 40 nm, the coating 502 can add a significant amount to the total magnetic spacing. Thus, the coating 502 provides benefits in a limited area, while reducing the recording/readback performance. Further, the coating 502 may obscure the fiducial markings 410 (FIG. 4), increasing the complexity of the assembly process. In addition, if an insulating layer in a bi-layer structure, such as a SiN layer, is not uniform, the coating 502 may cause an electrical short between the read/write elements 404 and/or between the read or write element 404 and the AlTiC 408 if the wear resistant layer, such as the Ti/TiO₂ layer, is conductive.

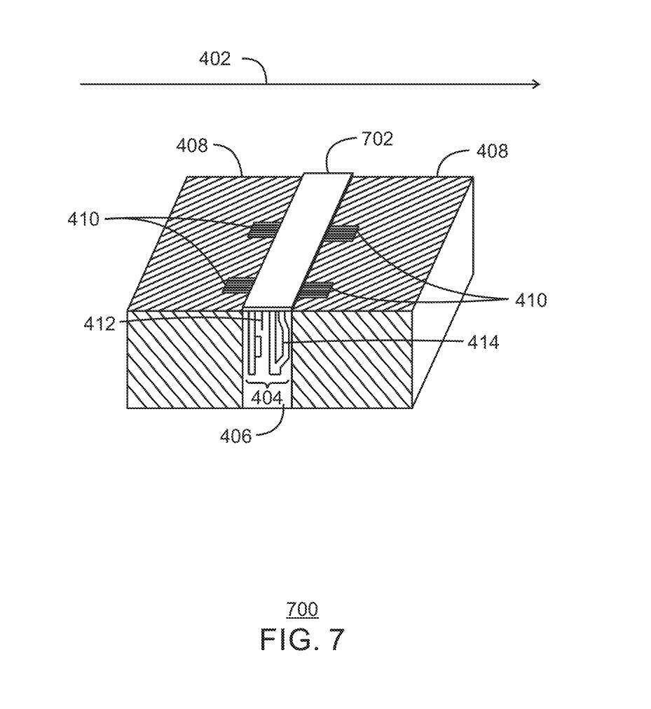

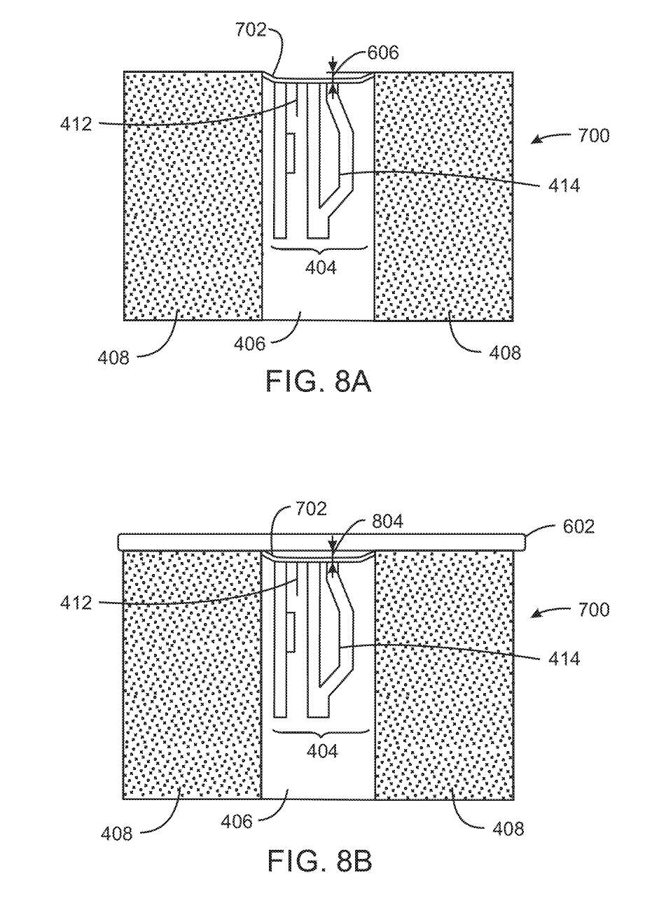

FIG. 7 is a drawing of a read/write head 700 that has a coating 702 that is only formed over the insulating layer 406 holding the read/write elements 404. Like numbered items are as described with respect to FIG. 4. As shown in FIG. 7, the coating can be removed or not deposited in regions where it has a deleterious effect on performance or process and retained or deposited in regions where it has a beneficial effect on performance and process. Restricting the coating to the insulating layer 406 allows the fiducial marks 410 to be seen, making assembly of the tape head 700 easier to perform. Further, restricting the coating can decrease the magnetic spacing, as discussed with respect to FIGS. 8A and 8B.

FIGS. 8A and 8B are cross sectional views of a read/write head 800 that has the coating formed only over the insulating region 406. Like numbered items are as described with respect to the previous figures. In FIG. 8B, a magnetic tape 602 is shown in contact with the TBS 408, which is unobstructed by the coating. The resultant magnetic spacing between the tape and the read/write elements 404, indicated by an arrow 804, is reduced in comparison to FIG. 6B. Further, the opportunity for shorting of the read/write elements 404 has been reduced. Because the coating 702 is formed over the insulating region 406 and the read/write elements 404, the head life is unaffected.

The coating 702 is not limited to the configurations shown in FIGS. 7 and 8, but can encompass any number of variations that have coatings formed only over regions that are sensitive to wear. In one example, the coating 702 can be formed over the read elements 412, the data reader shields, the servo readers, and the servo reader shields, e.g., allowing the write elements 414 to be exposed. In another example, the coating 702 can be formed over the read elements 412, the data reader shields, the writing elements 414, the servo readers, and the servo reader shields. In another example, the coating 702 can be formed over adjacent dielectric regions.

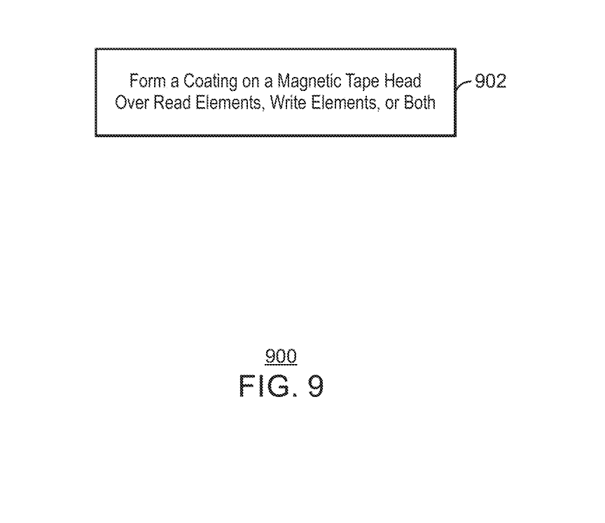

FIG. 9 is a method for forming a coating on a magnetic tape head over the read elements, the write elements, or both. In some examples, the coating can be formed over part of the structure by applying the coating over the entire structure and then removing it from areas, such as the TBS. Methods for removing the coating can include any number of physical and chemical processes, such as photolithography. In photolithography, a mask can be applied over the portions of the surface that will be uncoated. The coating can be applied by sputtering, and then lifted off by chemical or ion-beam etching. In another technique, a mechanical mask could be used to cover portions of the tape head during the coating deposition, blocking the coating from being applied to those locations.

Surface treatments may be used to modify the coating parameters. For example, a surface pre-treatment may be used to reduce the coating adhesion in the regions where it is not desirable. Similarly, a surface pre-treatment may be used to increase the coating adhesion in the regions where it is desirable.

In another example, a finished tape head can be assembled from individually formed pieces that are either completely coated or completely uncoated. This would have the advantage of controlling the coating to the precise regions desired. However, the assembly process may be more complicated than in some of the other procedures.

In addition to removing material, the coating may be applied to specific regions where it is desired. For example, an ion beam coating technique could be used.

The presently described technical examples may be susceptible to various modifications and alternative forms and have been shown only for illustrative purposes. For example, the present techniques may be used for previously assembled tape heads or during the assembly process. Furthermore, it is to be understood that the present techniques are not intended to be limited to the particular technical examples disclosed herein. Indeed, the scope of the appended claims is deemed to include all alternatives, modifications, and equivalents that are apparent to persons skilled in the art to which the disclosed subject matter pertains.

What is claimed is:

1. A magnetic read/write head comprising:
a read/write region comprising a read element and a write element;
a protective coating over the read element, the write element, or both, wherein the protective coating does not cover tape bearing surfaces disposed proximally to the read/write region, and wherein the protective coating is designed to protect the read/write region from wear.

2. The system of claim 1, wherein the protective coating comprises a layer of an insulating material and a layer of wear resistant material.

3. The system of claim 1, wherein the protective coating comprises a layer of silicon nitride and a layer of titanium with titanium oxide.

4. The system of claim 1, wherein the protective coating covers a read element at a first thickness and a write element at a second thickness.

5. The system of claim 1, wherein the read element has a protective coating and the write element does not.

6. The system of claim 1, wherein the read/write region is recessed relative to the tape bearing surfaces.

7. The system of claim 5, wherein the upper surface of the coating over the read/write region is substantially even with the tape bearing surfaces.

8. The system of claim 1, further comprising two tape bearing surfaces, wherein a first tape bearing surface is disposed in the direction of tape motion before the read/write head and a second tape bearing surface is disposed in the direction of tape motion after the read/write head.

9. The system of claim 7, wherein at least one of the two tape bearing surfaces is comprised of an alumina titanium carbide (AlTiC) composite.

10. The system of claim 1, wherein the read element is in a separate substrate from the write element.

11. A method for protecting a magnetic tape head, the method comprising forming a coating over elements on the magnetic tape head, wherein the elements can comprise read elements, write elements, or both and wherein the coating does not extend over adjacent tape bearing surfaces.

12. The method of claim 11, further comprising:
depositing a coating over a magnetic tape head; and
removing a portion of the coating, wherein the coating is left intact over at least a portion of the elements of the magnetic tape head.

13. The method of claim 11, wherein the coating is removed by photolithography, ion-beam etching, chemical etching, diamond lapping, or any combination thereof.

14. A tape drive comprising:
a tape head comprising a read/write region that comprises a read element and a write element, wherein a protective coating is disposed over the read element, the write element, or both, wherein the protective coating does not cover tape bearing surfaces disposed proximally to the read/write region, and wherein the protective coating is designed to protect the read/write region from wear; and
a tape transport mechanism comprising a supply reel, a take-up reel, and a drive mechanism.

15. The tape drive of claim 14, further comprising:
a tape cartridge, wherein the tape cartridge comprises the supply reel; and
a tape drive body, wherein the tape drive body comprises the take-up reel.
